(19) United States
(12) Patent Application Publication
(10) Pub. No.: US 2011/0183303 A1
(43) Pub. Date: Jul. 28, 2011

(54) OPERATION TRAINING SYSTEM AND PLANT OPERATION SUPPORTING SYSTEM

(75) Inventors: Takaya Yamamoto, Tokyo (JP); Kazuyuki Mori, Tokyo (JP)

(73) Assignee: MITSUBISHI ELECTRIC CORPORATION, Tokyo (JP)

(21) Appl. No.: 13/122,165

(22) PCT Filed: Apr. 21, 2009
(86) PCT No.: PCT/JP2009/057906

§ 371 Date: Apr. 1, 2011

(30) Foreign Application Priority Data
Dec. 2, 2008 (JP) 2008307230

(51) Int. Cl. G09B 19/00

(52) U.S. Cl. 434/219

(57) ABSTRACT

The present invention includes an operation training system, including: an operation training simulator obtained by modeling a real plant, for simulating a plant state of any one of during a normal operation and in case of an accident; training operation input means for inputting an operation for the operation training simulator; simulated accident information input means for inputting information of a simulated accident for allowing the operation training simulator to simulate the accident; a training operation procedure database in which operation procedures to be input for the normal operation and for the simulated accident during operation training are registered; training mis-operation detecting means for comparing the operation procedures registered in the training operation procedure database and the operation input to the training operation input means with each other to detect whether the input operation is a mis-operation; and a recovery operation scenario database for registering the operation procedure input to the training operation input means as an operation procedure for recovery of the plant state after the mis-operation is detected by the training mis-operation detecting means.

### TECHNICAL FIELD

The present invention relates to an operation training system and a plant operation supporting system, in particular an operation training system and a plant operation supporting system which are used for various plants such as a nuclear power plant.

### BACKGROUND ART

In general, for an operation of various plants such as a nuclear power plant, operation rules for normal operations (such as a steady state and start-up/stop) and operation rules for accident events are documented as a procedure manual. An operator operates a real plant according to the procedure manual.

A plant operation supporting system is installed in the real plant, for example, to present an operation procedure according to a plant state to the operator, to thereby support a plant operation performed by the operator.

As a conventional plant operation supporting system, there is a system described in Patent Document 1, for example. In general, for training the operator for normal operations of the plant and in preparation for accidents in the plant, an operation training simulator which simulates an operation of the real plant is generally used. In the plant operation supporting system described in Patent Document 1, information of mis-operations (erroneous operations) among the operations performed for the accident events by the operator using the operation training simulator during the training is collected so that a database of the information is created. In the case where the same accident event as that used for the training occurs during the operation of the real plant, the system makes a search through the database to display the contents of the mis-operations performed during the training and a frequency of occurrence thereof.

According to the plant operation supporting system described in Patent Document 1, data of operation training results is effectively used. As a result, effects of decreasing the likelihood that the operator performs the mis-operation during the operation of the real plant are obtained.

### CITATION LIST

### Patent Literature

[Patent Document 1] JP 10-268745 A

### SUMMARY OF INVENTION

### Technical Problem

In Patent Document 1, the efforts for decreasing the likelihood that the operator performs the mis-operation are made. In the case where the operator actually performs the mis-operation despite the efforts described above, however, there still exists a problem in that the operator is required to determine instantly, which recovery operation for the mis-operation is to be subsequently performed so as to reduce the influences of the mis-operation to stabilize a plant state, according to the plant state.

The present invention has been made to solve the problem described above, and therefore has an object to provide an operation training system and a plant operation supporting system, which are capable of supporting a subsequent operation in the case where an operator actually performs a mis-operation.

### Solution to Problem

The present invention relates to an operation training system, including: an operation training simulator obtained by modeling a real plant, for simulating a plant state of any one of during a normal operation and in case of an accident; training operation input means for inputting an operation for the operation training simulator; simulated accident information input means for inputting information of a simulated accident for allowing the operation training simulator to simulate the accident; a training operation procedure database in which operation procedures to be input for the normal operation and for the simulated accident during operation training are registered; training mis-operation detecting means for comparing the operation procedures registered in the training operation procedure database and the operation input to the training operation input means with each other to detect whether the input operation is a mis-operation; and a recovery operation scenario database for registering the operation procedure input to the training operation input means as an operation procedure for recovery of the plant state after the mis-operation is detected by the training mis-operation detecting means.

The present invention also relates to a plant operation supporting system including: the operation training system; operation input means for inputting an operation for a real plant; accident determination result input means for inputting information of an accident occurring during an operation of the real plant; an operation procedure database in which operation procedures to be input to the operation input means for the normal operation and in case of an accident are registered; mis-operation detecting means for comparing the operation procedures registered in the operation procedure database and the operation input to the operation input means to detect whether the input operation is a mis-operation; recovery operation scenario searching means for making a search for an operation procedure to be subsequently carried out for recovery of a plant state through a recovery operation scenario database of the operation training system based on a content of the mis-operation after the mis-operation is detected by the mis-operation detecting means; and recovery operation scenario display means for displaying a result of the search made by the recovery operation scenario searching means.

### Advantageous Effects of Invention

The operation training system according to the present invention includes: an operation training simulator obtained by modeling a real plant, for simulating a plant state of any one of during a normal operation and in case of an accident; training operation input means for inputting an operation for the operation training simulator; simulated accident information input means for inputting information of a simulated accident for allowing the operation training simulator to simulate the accident; a training operation procedure database in which operation procedures to be input for the normal operation and for the simulated accident during operation training are registered; training mis-operation detecting means for comparing the operation procedures registered in the training operation procedure database and the operation input to the training operation input means with each other to detect whether the input operation is a mis-operation; and a recovery operation scenario database for registering the operation procedure input to the training operation input means as an operation procedure for recovery of the plant state after the mis-operation is detected by the training mis-operation detecting means. Consequently, the operation training system is capable of supporting a subsequent operation in the case where an operator actually performs a mis-operation.

Further, the plant operation supporting system according to the present invention includes: the operation training system; operation input means for inputting an operation for a real plant; accident determination result input means for inputting information of an accident occurring during an operation of the real plant; an operation procedure database in which operation procedures to be input to the operation input means for the normal operation and in case of an accident are registered; mis-operation detecting means for comparing the operation procedures registered in the operation procedure database and the operation input to the operation input means to detect whether the input operation is a mis-operation; recovery operation scenario searching means for making a search for an operation procedure to be subsequently carried out for recovery of a plant state through a recovery operation scenario database of the operation training system based on a content of the mis-operation after the mis-operation is detected by the mis-operation detecting means; and recovery operation scenario display means for displaying a result of the search made by the recovery operation scenario searching means. Consequently, the plant operation supporting system is capable of supporting a subsequent operation in the case where an operator actually performs a mis-operation.

### BRIEF DESCRIPTION OF DRAWING

FIG. 1 A block diagram illustrating a configuration of an operation training system and an operation supporting system using the operation training system according to Embodiment 1 of the present invention.

### DESCRIPTION OF EMBODIMENT

### Embodiment 1

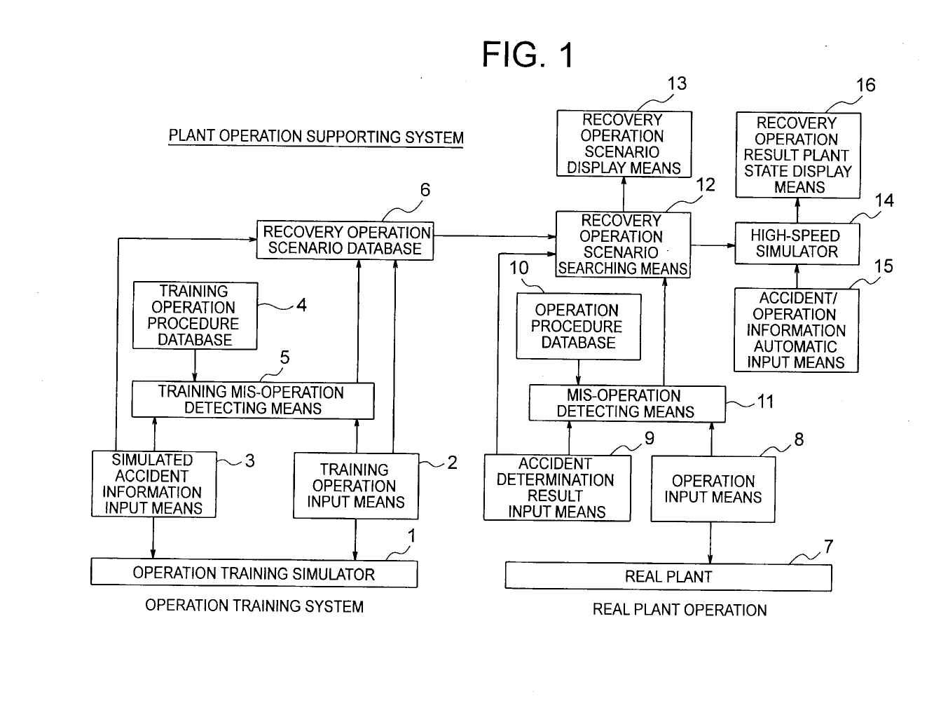

FIG. 1 is a block diagram illustrating an overall configuration of a plant operation supporting system according to Embodiment 1 of the present invention.

As illustrated in FIG. 1, the plant operation supporting system includes: an operation training system including an operation training simulator 1, training operation input means 2, simulated accident information input means 3, a training operation procedure database 4, training mis-operation detecting means 5, and a recovery operation scenario database 6; operation input means 8; accident determination result input means 9; an operation procedure database 10; mis-operation detecting means 11; recovery operation scenario searching means 12; recovery operation scenario display means 13; a high-speed simulator 14; accident/operation information automatic input means 15; and recovery operation result plant state display means 16. The plant operation supporting system is connected to a real plant 7.

In the configuration illustrated in FIG. 1, the operation training system using the operation training simulator 1 includes the operation training simulator 1, the training operation input means 2, the simulated accident information input means 3, the training operation procedure database 4, the training mis-operation detecting means 5, and the recovery operation scenario database 6. Hereinafter, the above-mentioned components are described sequentially.

The operation training simulator 1 is obtained by modeling the real plant 7 and is a device capable of simulating a plant state in the case where various accident events occur and a plant state during normal operations such as a steady state and start-up/stop states.

The training operation input means 2 is means which allows an operator to perform an operation (or a manual control) for opening/closing a valve of the plant, starting and stopping a pump, and the like during training. The operation training simulator 1 performs simulation based on the input. The training operation input means 2 may be input means having the same functions as those of the operation input means 8 for a real system, which is used for the operation of the real plant 7 (however, is different as hardware), or may be input means having a reduced number of controllable input items or using a simplified input method for the purpose of operation training. For example, when the operation input means 8 for the real system is a button or a switch, the training operation input means 2 may be a GUI input using a mouse or a keyboard which simulates the input with the bottom or the switch.

The simulated accident information input means 3 is means which allows an instructor (a training coach) to enter information of a simulated accident (including a type, a location, and a magnitude) to the operation training simulator 1. Based on the input, the operation training simulator 1 simulates an accident event. The simulated accident information input means 3 has a menu for the type, location, and magnitude of the simulated accident, which is prepared in advance, and has a configuration which allows the instructor to make selection and specification from the menu for input.

The training operation procedure database 4 is a database in which operation procedures for the normal operations and in case of an accident are registered. The operation procedures are to be input by the operator to the training operation input means 2. Therefore, the contents to be registered are the same as the contents of the operation procedure database 10 connected to the real plant 7. The two databases 4 and 10 may be physically the same database on a computer system (specifically, a common database may be used as the training database and the database for the real plant).

The training mis-operation detecting means 5 constantly monitors the input performed by the operator to the training operation input means 2 even during the normal operation and is capable of detecting an operation which is not registered in the training operation procedure database 4 as a mis-operation when the unregistered operation is performed. Moreover, when simulated accident information is input to the simulated accident information input means 3, the training mis-operation detecting means 5 makes a search for an operation procedure corresponding to the simulated accident input to the simulated accident information input means 3 through the training operation procedure database 4 and compares the result of the search with the input to the training operation input means 2, which is performed by the operator in training, to detect whether or not the operation performed by the operator is a mis-operation. Note that, the training mis-operation detecting means 5 is means having the same functions as those of the mis-operation detecting means 11 for the real system, which is used for supporting the operation of the real plant 7 (however, is different as hardware).

The recovery operation scenario database 6 is a database in which the accident information (the type, location, and magnitude of the accident) input from the simulated accident information input means 3, the contents and timing of the mis-operation detected by the training mis-operation detecting means 5, and the contents and timing of all the operations after the start of the simulated accident or an operation for the recovery of the plant state after the mis-operation is performed are registered. In the recovery operation scenario database 6, not only the data for the simulated accidents but also the contents of the mis-operation and the contents of a recovery operation for the mis-operation when the operator performs the mis-operation during the normal operation may be registered.

Next, the operation of the real plant 7 using the above-mentioned operation training system is described. In the configuration illustrated in FIG. 1, the real plant 7 is operated by the real plant 7, the operation input means 8, the accident determination result input means 9, the operation procedure database 10, the mis-operation detecting means 11, the recovery operation scenario searching means 12, the recovery operation scenario display means 13, the high-speed simulator 14, the accident/operation information automatic input means 15, and the recovery operation result plant state display means 16. Hereinafter, the above-mentioned components are described sequentially.

The operation input means 8 is means which allows the operator to perform an operation for opening/closing the valve and for starting/stopping the pump, for the operation of the real plant 7. The plant state of the real plant 7 changes based on the input. The operation input means 8 generally includes a hardware device such as a touch panel, a mouse, a keyboard, a button, or a switch for performing a software operation on a computer provided in a central supervisory control room.

The accident determination result input means 9 is means which allows the operator to input the type, location, and magnitude of the accident, which are specified or estimated based on various plant state monitoring parameters for the accident occurring during the operation of the real plant 7. The input to the accident determination result input means 9 is, for example, a GUI input using the touch panel, the mouse, the keyboard, and the like. If an input menu for the type, location, and magnitude of the accident is prepared in advance so that selection and specification are made therefrom for input, convenience is improved.

The operation procedure database 10 is a database in which the operation procedures for the normal operations of the real plant and in case of an accident in the real plant are registered.

The mis-operation detecting means 11 constantly monitors the input performed by the operator to the training operation input means 2 even during the normal operation and is capable of detecting an operation which is not registered in the operation procedure database 10 as a mis-operation when the unregistered operation is performed. Moreover, when the accident information is input to the accident determination result input means 9, the mis-operation detecting means 11 makes a search for an operation procedure corresponding to the type, location, and magnitude of the accident input to the accident determination result input means 9 based on the type, location, and magnitude of the accident through the operation procedure database 10 and compares a search result and the input to the operation input means 8 with each other to detect whether or not the operation is a mis-operation.

When the mis-operation is detected by the mis-operation detecting means 11, the recovery operation scenario searching means 12 makes a search for the contents and timing of an operation to be performed subsequently so as to reduce the influences of the mis-operation and to stabilize the plant state through the recovery operation scenario database 6 based on the contents of the mis-operation (and, in addition, the information of the accident input to the accident determination result input means 9, the plant state, and the like as needed). Only one search result may be output. Alternatively, a plurality of different operation procedures may be output as the search results.

The recovery operation scenario display means 13 is display means such as a display, for displaying the result(s) of the search made by the recovery operation scenario searching means 12.

The high-speed simulator 14 is a simulator to be referred to during the operation of the real plant 7 and can perform simulation at a speed, for example, several to several tens of times faster than in real time. Note that, the simulation speed of the high-speed simulator 14 is not limited to the above-mentioned cases, and may be any speed at which the simulation can be performed at a higher speed than in real time and be determined appropriately within a technically possible range.

The accident/operation information automatic input means 15 is means for instructing the high-speed simulator 14 to simulate the simulated accident corresponding to the accident occurring in the real plant 7 and for automatically inputting the same operation as the result of the search made by the recovery operation scenario searching means 12 at the same timing to the high-speed simulator 14.

The recovery operation result plant state display means 16 displays the result of the simulation performed by the high-speed simulator 14 when the same operation as the result of the search made by the recovery operation scenario searching means 12 is input by the accident/operation information automatic input means 15. The display may be performed on the same monitor screen as that for the real plant 7 or may be performed on a simplified monitor screen which displays only main parameters.

Next, an operation of the operation training system according to Embodiment 1 is described. In the operation training system according to Embodiment 1, as information for supporting the operation of the real plant 7, the operation training simulator 1 is first used to perform the operation training in preparation for the accidents to enrich the contents of the recovery operation scenario database 6. In the operation training, the accident is simulated on the operation training simulator 1 by the input to the simulated accident information input means 3, which is performed by the instructor. When a signal for notification of the input of the simulated accident information is input from the simulated accident information input means 3 to the training mis-operation detecting means 5, the training mis-operation detecting means 5 constantly monitors the input, which is performed by the operator in training to the training operation input means 2, and compares the input to the training operation input means 2, which is performed by the operator in training , and the content of the operator registered in the training operation procedure database 4 with each other. When the operation which is not registered in the training operation procedure database 4 is performed by the operator, the operation is detected as a mis-operation. Then, together with the mis-operation information, the operation information of the recovery operation subsequently performed until the influences of the mis-operation are reduced to stabilize the plant state is registered in the recovery operation scenario database 6. The simulated accident information (the type, location, and magnitude of the accident) input to the simulated accident information input means 3 is also transmitted from the simulated accident information input means 3 to the recovery operation scenario database 6 so as to be registered therein together with the mis-operation information and the operation information of the recovery operation described above.

Next, an operation of the plant operation supporting system according to this embodiment is described. For the operation of the real plant 7, the database registered in the recovery operation scenario database 6 of the operation training system in the above-mentioned manner is used. In case of an accident in the real plant 7 during the operation of the real plant 7, the operator specifies or estimates the accident from the various plant state monitoring parameters and then inputs the information of the accident (the type, location, and magnitude) by the accident determination result input means 9. The input performed by the operator to the operation input means 8 is constantly monitored by the mis-operation detecting means 11. If an operation which is not registered in the operation procedure database 10 is performed by the operator, the recovery operation scenario searching means 12 is notified of the performed unregistered operation. The recovery operation scenario searching means 12 makes a search for recovery operations registered in the recovery operation scenario database 6 of the operation training system based on the contents of the mis-operation (and, in addition, the information of the accident, which is input to the accident determination result input means 9, the plant state, and the like). The search result(s) is/are displayed on the screen for the operator by the recovery operation scenario display means 13. The operator performs the operation for the recovery while viewing the search result(s). Further, the accident/operation information automatic input means 15 instructs the high-speed simulator 14 to simulate the simulated accident corresponding to the accident occurring in the real plant 7 and automatically inputs the same operation as the result of the search made by the recovery operation scenario searching means 12 to the high-speed simulator 14 at the same timing. The recovery operation result plant state display means 16 displays the result of the simulation performed by the high-speed simulator 14 when the accident and the operation are input by the accident/operation information automatic input means 15.

The plant operation supporting system according to Embodiment 1 operates in the manner as described above. Thus, if the accident occurs during the operation of the real plant 7 and the operator performs a mis-operation as a recovery operation for the accident, the information of operations to be subsequently performed and the results thereof are displayed on the recovery operation scenario display means 13. Therefore, the effects of allowing the operator to refer to the information to perform an appropriate operation can be obtained. However, the effect cannot be obtained in the prior art. Further, the plant state after the recovery operation which will be subsequently performed can be confirmed in advance. The confirmation of the plant state is useful for the determination of a shift of timing of the operation when, for example, the magnitude of the actually occurring accident differs from that used for the training. Therefore, the effects of more appropriately performing the operation can be obtained.

If some mis-operations are intentionally performed before the training for the subsequent recovery operation is carried out in the operation training system, this system becomes further effective. The training does not affect the real plant at all. Therefore, various types of mis-operations and various recovery operations for the mis-operations can be tested. As a result, the recovery operation scenario database 6 can be enriched and hence, can be effectively used during the operation of the real plant. Therefore, if not only the operator in training but also the instructor perform the operation training using the operation training simulator 1 to enrich the recovery operation scenario database 6, a further meaningful database can be created. Alternatively, a training result may be configured to be scored based on time (promptness) required to reduce the expansion of damage or for the recovery from the accident. The information to be registered in the recovery operation scenario database 6 may be, for example, the best ten operations among the previous training results.

Moreover, this system can be used even for supporting the operation of the plant during the normal operation, for example, for the start-up/stop thereof. In this case, the information to be input from the simulated accident information input means 3 is not an accident but an operation for, for example, “load reduction from 100% output to 15% output”. In this case, no particular instruction is issued from the simulated accident information input means 3 to the operation training simulator 1. Similarly, when the real plant 7 is operated, the information to be input to the accident determination result input means 9 is not an accident but “load reduction from 100% output to 15% output” in the case of the above-mentioned example.

As described above, the operation training system according to Embodiment 1 is a system for supporting the operation during the normal operation and in case of an accident in a nuclear power plant or the like and is configured to include the operation training simulator 1 for simulating the plant state during the normal operation and in case of an accident, the training operation input means 2, which allows the operator to operate the simulator, the simulated accident information input means 3 which allows the instructor to enter the accident information during the training, the training operation procedure database (first database) 4, in which the operation procedures for the normal operations and in case of an accident are registered, the mis-operation detecting means 5 for detecting the mis-operation performed by the operator, and the recovery operation scenario database (second database) 6 in which the operation procedure carried out for the recovery of the plant state after the mis-operation is performed during the training is registered. With the configuration described above, various types of mis-operations and various recovery operations for the mis-operations can be tested. As a result, the recovery operation scenario database 6 can be enriched.

Further, the plant operation supporting system according to this embodiment is configured to include the operation training system described above, the operation input means 8 for allowing the operator to operate the real plant 7, the accident determination result input means 9 for inputting the accident occurring during the operation of the real plant 7, the recovery operation scenario searching means 12 for making a search for the operation procedure to be subsequently performed through the recovery operation scenario database (second database) 6 when the mis-operation is performed for the accident occurring during the real plant 7, the recovery operation scenario display means 13 for displaying the result of the search made by the recovery operation scenario searching means 12, the high-speed simulator (high-speed simulation means) 14 for simulating the plant state in the case where the recovery operation scenario is carried out at a high speed, the accident/operation information automatic input means 15 for instructing the high-speed simulator 14 to simulate the simulated accident corresponding to the accident occurring in the real plant 7 and for automatically inputting the same operation as the result of the search made by the recovery operation scenario searching means 12 to the high-speed simulator 14 at the same timing, and the recovery operation result plant state display means 16 for displaying the result obtained by the high-speed simulator (high-speed simulation means) 14. With the above-mentioned configuration, if the accident occurs during the operation of the real plant 7, the operation for the accident, which is performed by the operator, is constantly monitored. If the operation which is not included in the operation procedure is performed, the search is made through the recovery operation scenario database 6. The information of the operation to be subsequently performed is displayed on the recovery operation scenario display means 13, while the result of the simulation, which shows the plant state in the case where the operation is performed, can be displayed on the recovery operation result plant state display means 16. Therefore, even in the case where the accident occurs during the operation of the real plant 7 and the operator performs the operation (mis-operation) for the accident , which is not described in the procedure manual, the operation procedure to be subsequently carried out, which is obtained based on the result of operation training, can be presented to the operator. Therefore, even in case of a mis-operation, the effects of reducing the subsequent influences on the real plant 7 as much as possible can be obtained if the operator performs the operation according to the presented operation procedure. Moreover, by the high-speed simulator 14, the result of simulation of the recovery operation can be viewed earlier than in real time. Thus, the operation can be performed while the plant state after the operation is predicted. Accordingly, the operator can act in a calm manner. Further, even if the displayed recovery operation is not appropriate and the result of simulation is not desirable, the operator can appropriately change the contents of operation while viewing the result of simulation.

In Embodiment 1 described above, the plant operation supporting system having the entire configuration illustrated in FIG. 1 is described. The plant operation supporting system is not limited to the above-mentioned case. For example, the plant operation supporting system may be configured to include only the recovery operation scenario database 6 in which the operation procedure input for the recovery of the plant state after the mis-operation is input during the operation training is registered, the recovery operation scenario searching means 12 for inputting the contents of the mis-operation input for the accident occurring during the operation of the real plant 7 to make a search for the operation procedure to be subsequently carried out through the recovery operation scenario database 6 based on the input, and the recovery operation scenario display means 13 for displaying the result of the search made by the recovery operation scenario searching means 12. In this case, the recovery operation scenario searching means 12 needs to be configured to input the contents of the mis-operation which is input from outside for the accident occurring during the operation of the real plant. Even in this case, when the operator performs the mis-operation in the case where the accident occurs in the real plant 7, the operation procedure to be carried out subsequently can be presented to the operator based on the result of operation training. Therefore, even in case of a mis-operation, the effects of reducing the subsequent influences on the real plant 7 as much as possible can be obtained if the operator performs the operation according to the presented operation procedure.

Alternatively, the plant operation supporting system according to the present invention may be configured to include only the high-speed simulator 14 for simulating the plant state at a higher speed than in real time, the accident/operation information automatic input means 15 for inputting the accident information of the accident occurring in the real plant 7 to the high-speed simulator 14 to instruct the high-speed simulator 14 to simulate the accident and for inputting the result of the search for the operation procedure to be carried out after the mis-operation for the accident occurring during the operation of the real plant 7 to input the same operation as the result of the search to the high-speed simulator 7 at the same timing so that the plant state is simulated at a higher speed than in real time, and the recovery operation result plant state display means 16 for displaying the result of the simulation performed by the high-speed simulator 14 when the accident information and the same operation as the result of the search are input by the accident/operation information automatic input means 15. In this case, the result of the search made by the recovery operation scenario searching means 12 or the result of the search corresponding thereto need to be configured to be input to the accident/operation information automatic input means 15. In this case, the same operation as the result of the search made by the recovery operation scenario searching means 12 is input to the high-speed simulator 14 at the same timing so that the result of the high-speed simulation can be viewed at a speed several to several tens of times faster than in real time. Therefore, before the operation actually affects the real plant 7, next countermeasure is taken. Accordingly, the expansion of damage can be reduced, while an appropriate operation can be quickly performed to efficiently and reliably recover the plant state.

### REFERENCE SIGNS LIST

1, operation training simulator; 2, training operation input means; 3, simulated accident information input means; 4, training operation procedure database; 5, training mis-operation detecting means; 6, recovery operation scenario database; 7, real plant; 8, operation input means; 9, accident determination result input means; 10, operation procedure database; 11, mis-operation detecting means; 12, recovery operation scenario searching means; 13, recovery operation scenario display means; 14, high-speed simulator; 15, accident/operation information automatic input means; 16, recovery operation result plant state display means.

1. An operation training system, comprising:
an operation training simulator obtained by modeling a real plant, for simulating a plant state of any one of during a normal operation and in case of an accident;
training operation input means for inputting an operation to the operation training simulator;
simulated accident information input means for inputting accident information of a simulated accident, the information including an accident type, an accident location, and an accident magnitude, for allowing the operation training simulator to simulate the accident;
a training operation procedure database in which operation procedures to be input for the normal operation and for the simulated accident during operation training are registered;
training mis-operation detecting means for comparing the operation procedures registered in the training operation procedure database and the operation input to the training operation input means with each other to detect whether the input operation is a mis-operation or not; and
a recovery operation scenario database for registering a content of the mis-operation, the accident information, the plant state after the mis-operation, and the operation procedure input to the training operation input means as an operation procedure for recovery of the plant state after the mis-operation is detected by the training mis-operation detecting means.

2. A plant operation supporting system, comprising:
the operation training system according to claim 1;
operation input means for inputting an operation to a real plant;
accident determination result input means for inputting accident information of an accident occurring during an operation of the real plant, the information including an accident type, an accident location, and an accident magnitude;
an operation procedure database in which operation procedures to be input to the operation input means for normal operation and in case of an accident are registered;
mis-operation detecting means for comparing the operation procedures registered in the operation procedure database and the operation input to the operation input means to detect whether the input operation is a mis-operation;
recovery operation scenario searching means for making a search at least one operation procedure to be subsequently carried out for recovery of a plant state among the plurality of operation procedures registered in the recovery operation scenario database of the operation training system based on a content of the mis-operation, the accident information, and the plant state after the mis-operation after the mis-operation is detected by the mis-operation detecting means; and
recovery operation scenario display means for displaying a result of the search made by the recovery operation scenario searching means.

3. A plant operation supporting system according to claim 2, further comprising:
a high-speed simulator for simulating the plant state at a speed higher than in real time;
accident/operation information automatic input means for inputting the accident information of the accident occurring in the real plant to the high-speed simulator to instruct the high-speed simulator to simulate the accident and for inputting the same operation as the result of the search made by the recovery operation scenario searching means to the high-speed simulator at the same timing so as to allow the high-speed simulator to simulate the plant state at a speed higher than in the real time; and
recovery operation result plant state display means for displaying a result of a simulation performed by the high-speed simulator when the accident information and the operation information are input by the accident/operation information automatic input means.

4. A plant operation supporting system, comprising:
a recovery operation scenario database in which operation procedures input for recovery of a plant state after input of a mis-operation performed for the normal operation and for the simulated accident during operation training, a content of the mis-operation, the accident information of the simulated accident including an accident type, an accident location, and an accident magnitude, and the plant state after the mis-operation are registered;
recovery operation scenario searching means for inputting the content of the mis-operation input for an accident occurring during an operation of a real plant to make a search for at least one operation procedure to be subsequently carried out among the plurality of operation procedures registered in the recovery operation scenario database based on the input, the accident information including an accident type, an accident location, and an accident magnitude, and the plant state after the mis-operation; and
recovery operation scenario display means for displaying a result of the search made by the recovery operation scenario searching means.

5. A plant operation supporting system, comprising:
a high-speed simulator for simulating a plant state at a speed higher than in real time;
accident/operation information automatic input means for inputting accident information of an accident occurring in a real plant to the high-speed simulator to instruct the high-speed simulator to simulate the accident and for inputting a result of a search for an operation procedure to be carried out after a mis-operation is performed for the accident occurring during an operation of the real plant to input the same operation as the result of the search to the high-speed simulator at the same timing so as to allow the high-speed simulator to simulate the plant state at a speed higher than in real time; and
recovery operation result plant state display means for displaying a result of a simulation performed by the high-speed simulator when the accident information and the operation information are input by the accident/operation information automatic input means.
